(19) United States
(12) Patent Application Publication
(10) Pub. No.: US 2018/0307856 A1
(43) Pub. Date: Oct. 25, 2018

(54) SYSTEM AND METHOD FOR MANAGING METADATA

(71) Applicant: ELECTRONICS AND TELECOMMUNICATIONS RESEARCH INSTITUTE, Daejeon (KR)

(72) Inventors: Minh Chau NGUYEN, Daejeon (KR); Hee Sun WON, Daejeon (KR)

(21) Appl. No.: 15/788,999

(22) Filed: Oct. 20, 2017

(30) Foreign Application Priority Data
Apr. 19, 2017 (KR) 10-2017-0050465

(51) Int. Cl. G06F 21/62

(52) U.S. Cl. CPC G06F 21/6218; H04L 67/42

(57) ABSTRACT

A system for managing metadata on the basis of fetching in a big data platform includes: one or more client servers, each including a service provider configured to provide a user with application sets corresponding to different services generated by different subjects and a metadata agent configured to query or update metadata corresponding to each of the services; and a master server configured to manage the metadata corresponding to each of the services.

### CROSS-REFERENCE TO RELATED APPLICATION

This application claims priority to and the benefit of Korean Patent Application No. 10-2017-0050465, filed on Apr. 19, 2017, the disclosure of which is incorporated herein by reference in its entirety.

### BACKGROUND

### 1. Field of the Invention

The present invention relates to a system and method for managing metadata, and more specifically, to a system and method for managing metadata on the basis of prefetching in a big data platform.

### 2. Discussion of Related Art

Recently, the big data era has begun with many innovations coming simultaneously from numerous sources, such as theorists, system builders, scientists and application designers.

With the increasing amounts of data to be processed from a variety of sources and also the diverse demands on data, more and more new big data services have been implemented. Each of these services often manages and uses its own metadata information in its own memory.

As a result, it is difficult for the services and authorized third parties to access the metadata by working together for specific purposes. In addition, in order to guarantee good performance, there is a problem in that moving all metadata of services into one database is required.

Accordingly, it is necessary for a big data platform to offer many kinds of data services for big data which is related to different pieces of metadata to a large number of users who have different demands on processing, accessing, and storing data.

To provide a variety of services for big data, a common approach is to use a high performance in-memory database to manage metadata. However, this approach has the following limitations regarding a big data platform.

First, an in-memory database often has a data size limitation because all pieces of data are stored in a main memory of a database server. This means that it is not possible to manage a large amount of growing metadata, which is an important feature of big data in a multitenant environment.

Second, it is difficult to guarantee access quality for and security of metadata when many services simultaneously request metadata stored in one place.

Finally, use of an in-memory database may solve a disk latency problem, but latency caused by other network communications has a significant impact on performance.

### SUMMARY OF THE INVENTION

Some embodiments of the present invention provide a system and method for managing metadata in a big data platform which allow a user to easily use a desired service related to metadata access with low latency by improving metadata management performance.

Meanwhile, the technical problems to be solved in the present embodiment are not limited to the above-mentioned technical problems, and there may be other technical problems.

In one general aspect, there is provided a system for managing metadata on the basis of fetching in a big data platform, the system including: one or more client servers, each including a service provider configured to provide a user with application sets corresponding to different services generated by different subjects and a metadata agent configured to query or update metadata corresponding to each of the services; and a master server configured to manage the metadata corresponding to each of the services.

In another general aspect, there is provided a method of managing metadata on the basis of fetching in a big data platform, the method including: receiving, by a service provider of a client server, a service request from a user; transmitting, by the service provider, a metadata request to a metadata agent of the client server to acquire metadata for processing the service request; forwarding, by the metadata agent, the metadata request to a metadata monitor of a master server; adding, by the metadata monitor, the metadata request to a metadata monitoring table of a meta-database; receiving, by a metadata pattern generator of the master server, the metadata request added to the metadata monitoring table, generating an access pattern on the basis of the metadata request, and storing the access pattern in an access pattern table of the meta-database; and fetching, by a metadata fetcher of the master server, a value of metadata currently required or expected to be required in the future from the meta-database on the basis of the stored access pattern and transmitting the value to the metadata agent.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram illustrating a metadata management system according to one embodiment of the present invention;

FIG. 2 is a diagram for describing configurations of a client server and a master server;

FIG. 3A and FIG. 3B are flowchart of metadata reading procedures of a method of managing metadata according to one embodiment of the present invention;

FIG. 4 is a diagram illustrating an example of an access pattern; and

FIG. 5 is a flowchart illustrating metadata writing procedures of a method of managing metadata according to one embodiment of the present invention.

### DETAILED DESCRIPTION OF EXEMPLARY EMBODIMENTS

The present invention will be described more fully hereinafter with reference to the accompanying drawings which show exemplary embodiments of the invention. However, the present invention may be embodied in many different forms and is not to be construed as being limited to the embodiments set forth herein. Also, irrelevant details have been omitted from the drawings for increased clarity and conciseness.

Throughout the detailed description, unless explicitly described to the contrary, the word “comprise” and variations such as “comprises” or “comprising,” should be understood to imply the inclusion of stated elements but not the exclusion of any other elements.

The present invention relates to a metadata management system 1 and a method of managing metadata on the basis of prefetching in a big data platform.

According to one embodiment of the present invention, metadata management performance is improved so that a user may easily use a desired service related to metadata access with low latency and a standard mechanism for reading and writing metadata may be provided to a flexible system.

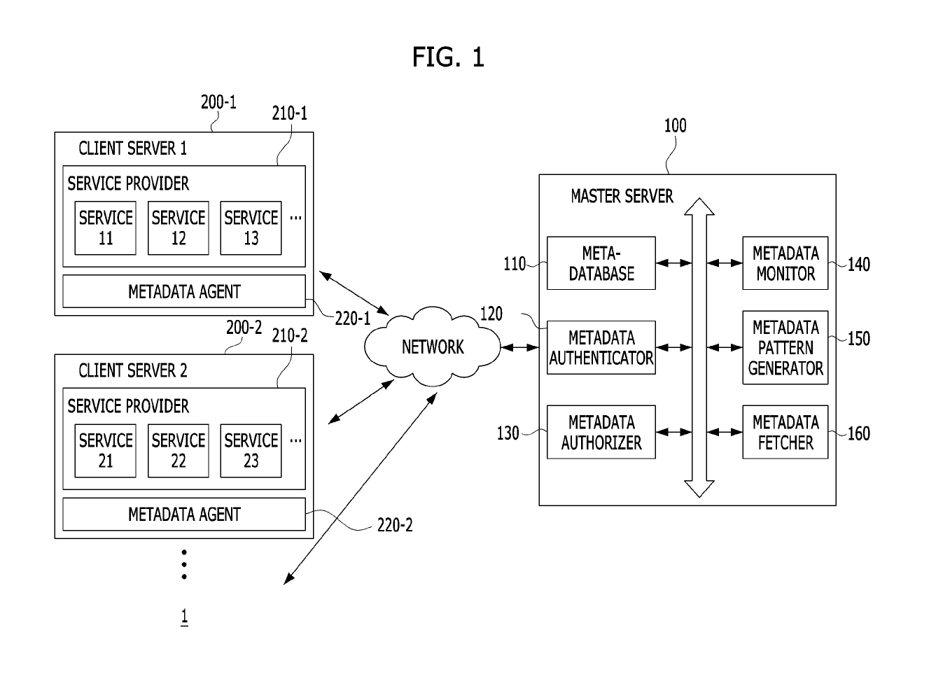

Hereinafter, the metadata management system 1 according to one embodiment of the present invention will be described with reference to FIG. 1.

FIG. 1 is a block diagram illustrating the metadata management system 1 according to one embodiment of the present invention.

The metadata management system 1 according to one embodiment of the present invention includes one or more client servers 200-1 to 200-N and a master server 100.

The one or more client servers 200 query or update metadata for their own data services.

In this case, each of the client servers includes a service provider 210-1 to 210-N and a metadata agent 220-1 to 220-N.

The service provider 210 provides application sets corresponding to different services individually generated by different subjects to a user. That is, the service provider 210 provides a series of application sets Service 11, Service 12, Service 13, etc. including web applications and mobile applications developed by different developers to provide different services to end users.

The metadata agent 220 interacts with the master server 100 and queries or updates the metadata corresponding to a service.

The master server 100 manages the metadata corresponding to the service.

In this case, the master server 100 includes a meta-database 110, a metadata authenticator 120, a metadata authorizer 130, a metadata monitor 140, a metadata pattern generator 150, and a metadata fetcher 160.

First, metadata corresponding to a user, a group, a quota, a resource, an application, and a cluster configuration is stored in the meta-database 110.

The metadata authenticator 120 authenticates metadata requests received from the metadata agents 220 on the basis of protocols, such as Kerberos, OpenID, and LDAP.

The metadata authorizer 130 authorizes a request for determining metadata that may be accessed by the metadata agent 220. That is, the metadata authorizer 130 determines whether a metadata access request contains an authorization violation on the basis of access authorization information stored in the meta-database 110.

The metadata monitor 140 monitors metadata requests from the metadata agents 220 and adds the metadata requests to a metadata monitoring table in the meta-database 110.

The metadata pattern generator 150 receives the metadata request stored in the meta-database 110, generates an access pattern on the basis of the metadata request, and stores the access pattern in an access pattern table in the meta-database 110.

The metadata fetcher 160 fetches a value of metadata that is currently required or expected to be required in the future from the meta-database 110 on the basis of the access pattern stored in the meta-database 110, and transmits the value to the metadata agent 220.

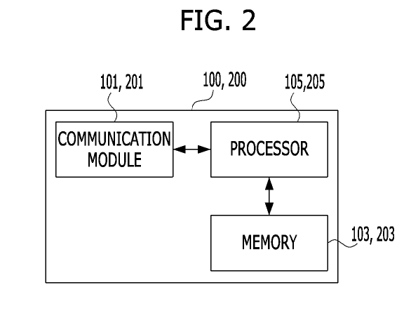

Components included in the client server 200 and the master server 100 of one embodiment of the present invention may be configured as shown in FIG. 2.

FIG. 2 is a diagram for describing configurations of the client server 200 and the master server 100.

Referring to FIG. 2, the master server 100 may include a communication module 101, a memory 103, and a processor 105, and the client server 200 may include a communication module 201, a memory 203, and a processor 205.

In this case, each of the communication modules 101 and 201 may include both a wired communication module and a wireless communication module. The wired communication module may be implemented with a power line communication device, a telephone line communication device, a cable home (MoCA), Ethernet, IEEE1294, an integrated wired home network, and an RS-484 control device. In addition, the wireless communication module may be implemented with a wireless local area network (WLAN), Bluetooth, a high data rate wireless personal area network (HDR WPAN), ultra-wideband (UWB), ZigBee, an impulse radio, 60 GHz WPAN, binary-code division multiple access (CDMA), a wireless universal serial bus (USB) technology, a wireless high definition multimedia interface (HDMI) technology, and the like.

Programs for controlling a corresponding server are stored in each of the memories 103 and 203. Each of the memories 103 and 203 collectively refers to a non-volatile storage device which retains stored information even when power is not supplied thereto and a volatile storage device.

For example, each of the memories 103 and 203 may include a NAND flash memory, such as a compact flash (CF) card, a secure digital (SD) card, a memory stick, a solid-state drive (SSD), and a micro SD card, a magnetic computer memory device, such as a hard disk drive (HDD), and an optical disc drive, such as a compact disc read-only memory (CD-ROM), a digital versatile disc (DVD)-ROM, and the like.

In addition, each of the client server 200 and the master server 100 further includes a user input device, a data communication bus, and a user output device. Each component in the servers may perform data communication through the data communication bus.

For reference, each component illustrated in FIG. 1 according to the embodiment of the present invention may be realized in the form of a software component or a hardware component such as a field programmable gate array (FPGA) or an application specific integrated circuit (ASIC), and may perform predetermined roles.

However, the “components” are not limited to software or hardware components, and each of the components may be configured to reside on an addressable storage medium and configured to be executed by one or more processors.

Thus, a component unit may include, by way of example, a component such as a software component, an object-oriented software component, a class component, and a task component, a process, a function, an attribute, a procedure, a subroutine, a segment of a program code, a driver, firmware, a microcode, circuitry, data, a database, a data structure, a table, an arrays, and a variable.

The components and functionality provided by the components may be combined into fewer components or further separated into additional components.

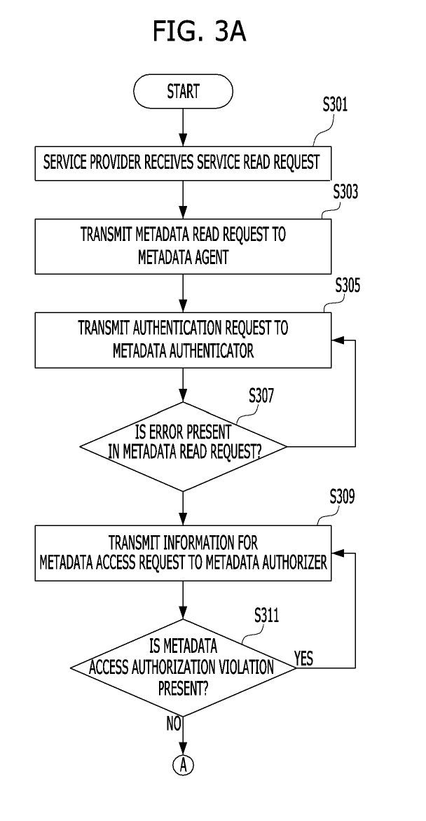

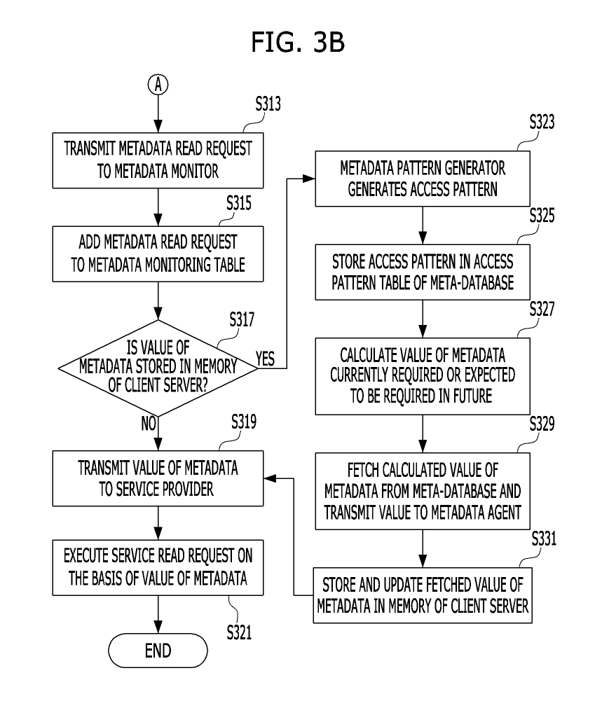

Hereinafter, a method of managing metadata in the metadata management system 1 will be described in more detail with reference to FIGS. 3A to 5.

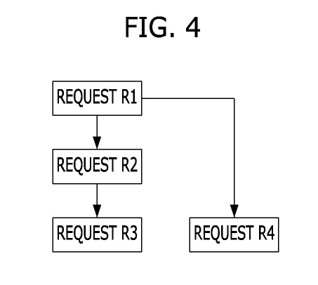

FIG. 3A and FIG. 3B are flowchart of metadata reading procedures of a method of managing metadata according to one embodiment of the present invention. FIG. 4 is a diagram illustrating an example of an access pattern.

In metadata reading procedures in the metadata management system 1 according to one embodiment of the present invention, the service provider 210 of the client server 200 receives a specific service read request from a user (S301).

Then, the service provider 210 transmits a metadata read request to the metadata agent 220 to acquire metadata required for processing the service read request (S303). In this case, the metadata read request may include at least one of a user ID, a tenant ID, a service ID, a metadata table ID, and a row and column ID of metadata.

Then, the metadata agent 220 transmits an authentication request including an ID and password of the metadata agent 220 to the metadata authenticator 120 (S305), and accordingly, the metadata authenticator 120 determines whether there is an error in the metadata read request on the basis of information of the metadata agent 220 stored in the metadata (S307).

When it is determined that an error exists, the metadata agent 220 retransmits the authentication request including the ID and password of the metadata agent 220 to the metadata authenticator 120 (S305).

Conversely, when it is determined that there is no error, the metadata agent 220 transmits information for a metadata access request to the metadata authorizer 130 (S309). In this case, the information for a metadata access request may include at least one of the metadata agent ID, the user ID, the tenant ID, the service ID, the metadata table ID, and the row and column ID of metadata.

The metadata authorizer 130 which receives the information determines whether the metadata access request contains an authorization violation on the basis of access authorization information stored in the meta-database 110 (S311).

When it is determined that there is an authorization violation, the metadata agent 220 retransmits the information for a metadata access request to the metadata authorizer 130 (S309).

When it is determined that there is no access authorization violation, the metadata agent 220 transmits the metadata read request to the metadata monitor 140 (S313), and the metadata monitor 140 which receives the metadata read request adds the metadata read request to a metadata monitoring table in the meta-database 110 (S315).

Then, the metadata agent 220 checks whether a value of the metadata required for processing the user's service read request is stored in a memory of the client server 200 (S317).

When the check result indicates that the value of the metadata is stored in the memory, the metadata agent 220 transmits the value of the metadata to the service provider 210 of the client server 200 (S319), and the service provider 210 which receives the corresponding value provides a service to the user by executing the service read request on the basis of the received value (S321).

Conversely, when the check result indicates that the value of the metadata is not stored in the memory, the metadata pattern generator 150 reads a metadata read request from the metadata monitoring table in the meta-database 110 and generates an access pattern on the basis of the metadata read request (S323).

In this case, the access pattern may refer to, for example, a set of requests in a directed spanning tree. A directed edge in an arborescent form may be directed to a request which has the most number of similar elements, such as a user ID and a service ID, i.e., a request which has the most number of elements whose similarity is greater than or equal to a predetermined similarity. Thus, when one route set from a vertex A to a vertex B which is different from the vertex A exists, a directed graph having exactly one direct path from A to B may be formed with the vertices A and B.

Referring to FIG. 4, when metadata read requests R3, R2, and R1 are present and they have 1, 2 and 3 elements similar to a current request R4, an access pattern is generated according to a directed edge from the request R1 to the request R4.

Meanwhile, in one embodiment of the present invention, when the largest number of elements similar to the current request is less than 2, a new access pattern including the current request may be generated instead of adding the current request to the existing access pattern.

As the new access pattern is generated and added or the existing access pattern is updated, the metadata pattern generator 150 stores the access pattern in an access pattern table of the meta-database 110 (S325).

Then, the metadata fetcher 160 calculates a value of metadata currently required or expected to be required in the future on the basis of the access pattern stored in the access pattern table of the meta-database 110 (S327).

For example, when the current request R5 has exactly the same elements as the request R1, the metadata required in the future according to the pattern shown in FIG. 4 may be the metadata of the requests R2, R3 and R4.

Then, the metadata fetcher 160 fetches the calculated value of the metadata from the meta-database 110 and transmits the value to the metadata agent 220 (S329).

The metadata agent 220 which receives the value of the metadata stores and updates the value in the memory of the client server 200 (S331), and thereafter, transmits the value of the metadata to the service provider 210 of the client server (S319). The service provider 210 which receives the value of the metadata may provide a service to the user by executing the service read request on the basis of the received value (S321).

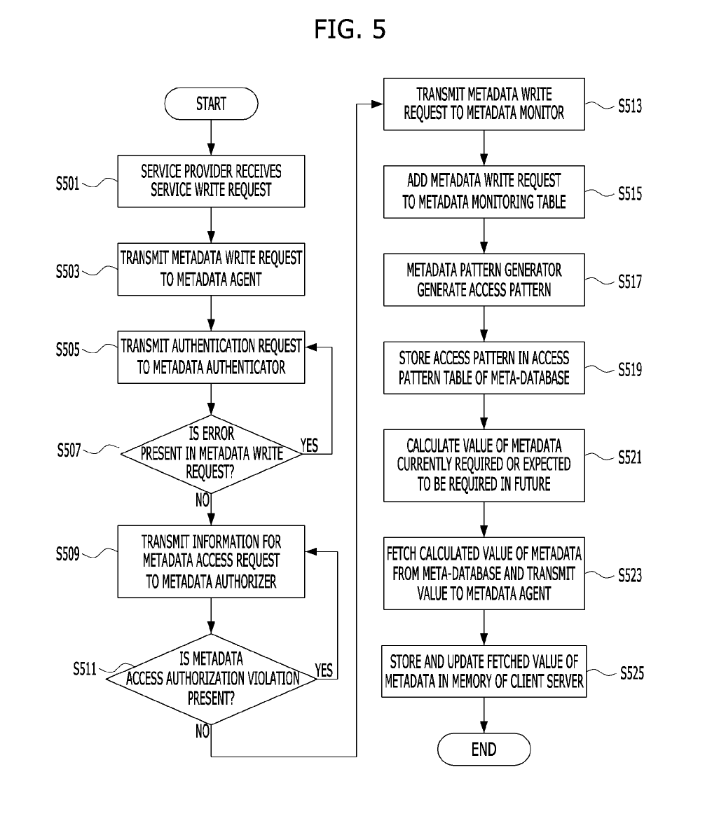

FIG. 5 is a flowchart illustrating metadata writing procedures of a method of managing metadata according to one embodiment of the present invention.

In metadata writing procedures in the metadata management system 1 according to one embodiment, first, the service provider 210 of the client server 200 receives a specific service write request from a user (S501).

Then, the service provider 210 transmits a metadata write request including at least one of a user ID, a tenant ID, a service ID, a metadata table ID, and a row and column ID of metadata to the metadata agent 220 to process the service write request (S503).

Then, the metadata agent 220 transmits an authentication request including an ID and password of the metadata agent 220 to the metadata authenticator 120 (S505), and accordingly, the metadata authenticator 120 determines whether there is an error in the metadata write request on the basis of information of the metadata agent 220 stored in metadata (S507).

When it is determined that there is an error, the metadata agent 220 retransmits the authentication request including the ID and password of the metadata agent 220 to the metadata authenticator 120 (S505).

By contrast, when there is no error, the metadata agent 220 transmits information for a metadata access request which includes at least one of the metadata agent ID, the user ID, the tenant ID, the service ID, the metadata table ID, and the row and column ID of metadata to the metadata authorizer 130 (S509).

The metadata authorizer 130 which receives the information determines whether the metadata access request contains an authorization violation on the basis of access authorization information stored in the meta-database 110 (S511).

When it is determined that there is an access authorization violation, the metadata agent 220 retransmits the information for a metadata access request to the metadata authorizer 130 (S509).

Conversely, when it is determined that there is no access authorization violation, the metadata agent 220 transmits the metadata write request to the metadata monitor 140 (S513), and the metadata monitor 140 which receives the metadata write request adds the metadata write request to a metadata monitoring table of the meta-database 110 (S515).

Then, the metadata pattern generator 150 reads the metadata write request from the metadata monitoring table of the meta-database 110 and generates an access pattern on the basis of the metadata write request (S517).

In addition, as a new access pattern is generated and added or an existing access pattern is updated, the metadata pattern generator 150 stores pertinent access pattern in an access pattern table of the meta-database 110 (S519).

Then, the metadata fetcher 160 calculates a value of metadata currently required or expected to be required in the future on the basis of the access pattern stored in the access pattern table of the meta-database 110 (S521).

Thereafter, the metadata fetcher 160 fetches the calculated value of the metadata from the meta-database 110 and transmits the value to the metadata agent 220 (S523). The metadata agent 220 stores and updates the fetched value of the metadata in a memory of the client server 200 (S525).

Meanwhile, in the above description, operations S301 to S525 may be further divided into additional operations or combined into fewer operations according to embodiments of the present invention. In addition, some of the operations may be omitted if necessary, and the order of the operations may be changed. Further, any omitted descriptions of components or operations related to the metadata management system 1 described with reference to FIGS. 1 and 2 may be applied to the embodiments of the method of managing metadata described with reference to FIGS. 3A to 5.

According to any of the above-described embodiments of the present invention, it is possible to solve a performance degradation problem which may occur in integrated metadata management for various services.

In addition, it is possible to easily provide a desired service with low latency to a user and to securely provide access to metadata even in other systems.

The method of managing metadata in the metadata management system 1 according to one embodiment of the present invention may be implemented in the form of a computer program stored in a medium executed by a computer or a recording medium that includes computer executable instructions. The computer-readable medium may be any usable medium that can be accessed by a computer and may include all volatile and nonvolatile media and detachable and non-detachable media. Also, the computer-readable medium may include all computer storage media and communication media. The computer storage medium includes all volatile and nonvolatile media and detachable and non-detachable media implemented by a certain method or technology for storing information such as computer-readable instructions, data structures, program modules, or other data. The communication medium typically includes computer-readable instructions, data structures, program modules, other data of a modulated data signal such as a carrier wave, or other transmission mechanisms, and includes information transmission media.

The method and system of the present invention have been described in connection with specific embodiments of the invention, and some or all of the components or operations thereof may be realized using a computer system that has general-use hardware architecture.

The foregoing description of the invention is for illustrative purposes, a person having ordinary skilled in the art should appreciate that other specific modifications can be easily made thereto without departing from the technical spirit or essential features of the invention. Therefore, the foregoing embodiments should be regarded as illustrative rather than limiting in all aspects. For example, each component described as being of a single type can be implemented in a distributed manner. Likewise, components described as being distributed can be implemented in a combined manner.

The scope of the present invention is not defined by the detailed description as set forth above but by the accompanying claims of the invention. It should also be understood that all changes or modifications derived from the definitions and scopes of the claims and their equivalents fall within the scope of the invention.

What is claimed is:

1. A system for managing metadata on the basis of fetching in a big data platform, the system comprising:
one or more client servers, each including a service provider configured to provide a user with application sets corresponding to different services generated by different subjects and a metadata agent configured to query or update metadata corresponding to each of the services; and
a master server configured to manage the metadata corresponding to each of the services.

2. The system of claim 1, wherein, when the service provider of the client server receives a service request for a specific service from the user, the service provider transmits a metadata request to the metadata agent to acquire metadata required for processing the service request.

3. The system of claim 2, wherein the service request is a read request or a write request for the service and the metadata request is a read request for metadata corresponding to the read request for the service or a write request for metadata corresponding to the write request for the service.

4. The system of claim 3, wherein, when the service request is the read request for the service, the metadata agent transmits a value of the required metadata to the service provider when the value is stored in a memory of the client server, and the service provider provides the service to the user by executing the read request for the service on the basis of the value of the metadata.

5. The system of claim 3, wherein the master server includes a meta-database in which metadata corresponding to a user, a group, a quota, a resource, an application, and a cluster configuration is stored and a metadata pattern generator configured to receive the metadata request stored in the meta-database, generate an access pattern on the basis of the metadata request, and store the access pattern in an access pattern table of the meta-database.

6. The system of claim 5, wherein when the service request is the read request for the service, the metadata pattern generator generates the access pattern and stores the access pattern in the access pattern table of the meta-database when the metadata agent confirms that the value of the required metadata is not present in the memory of the client server.

7. The system of claim 5, wherein the master server includes a metadata fetcher configured to fetch a value of metadata currently required or expected to be required in the future from the meta-database on the basis of the access pattern stored in the meta-database, and transmit the fetched value to the metadata agent.

8. The system of claim 7, wherein the metadata agent receives the value of the metadata and stores and updates the value in the memory of the client server.

9. The system of claim 5, wherein the master server includes a metadata authenticator configured to authenticate the metadata request received from the metadata agent, wherein the metadata authenticator determines whether there is an error in the metadata request on the basis of information of the metadata agent stored in the meta-database.

10. The system of claim 9, wherein the master server further includes a metadata authorizer configured to authorize a request for determining metadata which is accessible by the metadata agent, wherein when the metadata authenticator determines that there is no error in the metadata request, the metadata authenticator transmits information for a metadata access request to the metadata authorizer.

11. The system of claim 10, wherein the metadata request includes at least one of a user ID, a tenant ID, a service ID, a metadata table ID, and a row and column ID of metadata, and the metadata access request includes at least one of a metadata agent ID, the user ID, the tenant ID, the metadata table ID and the row and column ID of the metadata.

12. The system of claim 10, wherein the metadata authorizer determines whether the metadata access request contains an authorization violation on the basis of access authorization information stored in the meta-database.

13. The system of claim 12, wherein the master server includes a metadata monitor configured to monitor the metadata request from the metadata agent, wherein when the metadata access request does not contain an authorization violation, the metadata agent transmits the metadata request to the metadata monitor and the metadata monitor adds the metadata request to a metadata monitoring table of the meta-database, and the metadata pattern generator receives the metadata request added to the metadata monitoring table.

14. A method of managing metadata on the basis of fetching in a big data platform, the method comprising:
receiving, by a service provider of a client server, a service request from a user;
transmitting, by the service provider, a metadata request to a metadata agent of the client server to acquire metadata for processing the service request;
forwarding, by the metadata agent, the metadata request to a metadata monitor of a master server;
adding, by the metadata monitor, the metadata request to a metadata monitoring table of a meta-database;
receiving, by a metadata pattern generator of the master server, the metadata request added to the metadata monitoring table, generating an access pattern on the basis of the metadata request, and storing the access pattern in an access pattern table of the meta-database; and
fetching, by a metadata fetcher of the master server, a value of metadata currently required or expected to be required in the future from the meta-database on the basis of the stored access pattern, and transmitting the value to the metadata agent.

15. The method of claim 14, further comprising receiving, by the metadata agent, the value of the metadata from the metadata fetcher and storing and updating the value in a memory of the client server.

16. The method of claim 14, wherein the service request is a read request or a write request for a specific service and the metadata request is a read request for metadata corresponding to the read request for the service or a write request for metadata corresponding to the write request for the service.

17. The method of claim 16, wherein when the service request is the read request for the service, the generating and storing of the access pattern includes generating, by the metadata pattern generator, the access pattern and storing the access pattern in the access pattern table of the meta-database when the metadata agent confirms that the value of the required metadata is not present in a memory of the client server.

18. The method of claim 17, wherein when the metadata agent confirms that the value of the required metadata is stored in the memory of the client server, the method further comprises:
Transmitting, by the metadata agent, the value of the metadata to the service provider; and
providing, by the service provider, a service to the user by executing the read request for the service on the basis of the value of the metadata.

19. The method of claim 14, further comprising:
determining, by a metadata authenticator of the master server, whether there is an error in the metadata request on the basis of information of the metadata agent stored in the meta-database; and
transmitting information for a metadata access request to a metadata authorizer of the master server when it is determined that there is no error in the metadata request.

20. The method of claim 19, further comprising determining, by the metadata authorizer, whether the metadata access request contains an authorization violation on the basis of access authorization information stored in the meta-database,
wherein the forwarding of the metadata request, by the metadata agent, to the metadata monitor of the master server includes transmitting the metadata request to the metadata monitor when the metadata access request does not contain an authorization violation.
